(19) United States
(12) Patent Application Publication
(10) Pub. No.: US 2008/0082420 A1
(43) Pub. Date: Apr. 3, 2008

(54) Method for Dynamic Group Formation and Purchasing

(76) Inventors: James B. Kargman, Chicago, IL (US); Marc Asher, Highland Park, IL (US)

Correspondence Address: SCHIFF HARDIN, LLP;PATENT DEPARTMENT, 6600 SEARS TOWER, CHICAGO, IL, 60606-6473, US

(21) Appl. No.: 11/866,903

(22) Filed: Oct. 3, 2007

Related U.S. Application Data
(60) Provisional application No. 60/849,202, filed on Oct. 3, 2006.
(60) Provisional application No. 60/850,035, filed on Oct. 5, 2006.

(51) Int. Cl. G06Q 30/00

(52) U.S. Cl. 705/14

(57) ABSTRACT

A method provides for group purchasing of a product or service, comprising determining, by a first customer, a product or service to purchase from a vendor, contacting, by the first customer, a second customer interested in purchasing the product or services, establishing a customer-defined group identity with the first and second customer being group members, purchasing the product or service from the vendor by the first and second customer using the group identity, and providing, by the vendor, a benefit that is at least one of a pre-purchase incentive and a post-purchase reward to the first and second customer based on the group identity. The sequencing of the method steps can be varied, and various incentive and communication arrangements can also be varied.

### CROSS REFERENCE TO RELATED APPLICATIONS

The present application claims the benefit of U.S. Provisional Application No. 60/849,202, filed Oct. 3, 2007, entitled, “Method for Dynamic Group Formation and Purchasing”, and U.S. Provisional Application No. 60/850,035, filed Oct. 5, 2007, entitled, “Method for Implementing a Buying Ring by Cell Phone”, both herein incorporated by reference.

### BACKGROUND

As illustrated in FIG. 1, in traditional marketing, a vendor 10 has direct contact 20 to the consumer 12 via e-mail, direct mail, TV, radio, newspaper, the Internet and at the point of purchase. This marketing can either be via a one-on-one relationship or utilize multi-channel marketing. The consumer 12 is an individual point in direct relationship with the company 10.

Furthermore, numerous mechanisms have been historically utilized between buyers of goods and services 12 and the respective vendors 10 to utilize aggregate purchasing power of groups of consumers. A common example of this is a co-op, in which a person signs up with the co-op as a member, possibly by paying a fee, and the members of the co-op are able to avail themselves of discounts offered by various sellers due to their membership in a larger buying bloc. In these programs, the shopper acts as an individual from the standpoint that he has no ability to influence the level of discount or incentive received—it is set solely by the administrator of the co-op who negotiates with the sellers.

Also, frequent buyer programs are known, such as diner clubs, whereby the customer's own buying patterns can increase the level of discount or incentive he receives. Such incentives can be in the form of an instant discount or future credit. Some such programs require an up-front fee, whereas others are free. Although in this scenario, as illustrated in FIG. 2, the volume of purchasing 22 by the individual 12 can influence his incentive amount 24, the shopper 12 still acts as an individual and his level of discount is not influenced by anyone else's buying behavior. The individual does not have any real power for influencing pricing except by his own buying activity.

Community web sites are known where people get together to discuss and recommend products (e.g., www.epinions.com), but despite the communal setting, the shopper still ultimately acts as an individual at purchase time. Also, web sites are known that run Dutch auctions, whereby the price of a particular product or service continually drops until someone makes a purchase. In that scenario, the price is influenced by the behavior of other people interested in the same product, but the buying strength is actually decreased instead of increased for the consumer because they are in competition, instead of cooperation, with other buyers.

It is further known to offer a product on a web site wherein the price of the item drops when more people are willing to buy the product during a certain period of time.

The concept of viral marketing has proven beneficial for selling products, particularly in light of the Internet. In its simplest form, and as illustrated in FIG. 3, viral marketing relies upon a customer C₁ 12 of a vendor 10 to initiate contact with another person C₂ to interest them in the products of the vendor 10. This then distinguishes the contact from spam or other mass-marketing techniques used by the vendor in that it is provided by someone known to the recipient.

Peer-to-peer marketing is much more effective--advantageously, this type of marketing not only gives the vendor contacts that would not otherwise be available, but in the context of the Internet, allows the vendor to package the content while at the same time having the customer “endorse” the content to his friends.

By way of example, a person orders a product from a vendor's web site and then is asked by the web site to provide, e.g., an e-mail address for a friend via which the vendor can expand its potential customer base. Alternately, incentives can be provided by a vendor in a system such as that used by DirectTV® wherein a purchaser is given an incentive if he can persuade others to sign up. However, there is no further incentive provided beyond getting the new person to sign up.

What is needed, therefore, is a mechanism to combine the notion of viral marketing with that of giving consumers the benefit of aggregate buying power in a dynamic context.

### SUMMARY

The present invention provides a mechanism that combines the notion of viral marketing with an ability of consumers to dynamically form buying blocs that would entitle them to discounted pricing.

Accordingly, a method is provided for determining, by a first customer, a product or service to purchase from a vendor, contacting, by the first customer, a second customer interested in purchasing the product or services, establishing a customer-defined group identity with the first and second customer being group members, purchasing the product or service from the vendor by the first and second customer using the group identity, and providing, by the vendor, a benefit that is at least one of a pre-purchase incentive and a post-purchase reward to the first and second customer based on the group identity. The sequencing of the method steps can be varied, and various incentive and communication arrangements can also be varied.

### DESCRIPTION OF THE DRAWINGS

The invention is explained with reference to various preferred embodiments illustrated in the drawings and explained in more detail below.

FIG. 1 is a pictorial illustration of an existing traditional marketing structure;

FIG. 2 is a pictorial illustration of a traditional rewards program;

FIG. 3 is a pictorial illustration of a traditional viral marketing program;

FIG. 4 is a pictorial illustration of an embodiment of the inventive buying program;

FIG. 5 is a pictorial illustration of the viral marketing hierarchical structure; and

FIG. 6 is a screen shot illustrating an exemplary web page for accessing an implementation of the system.

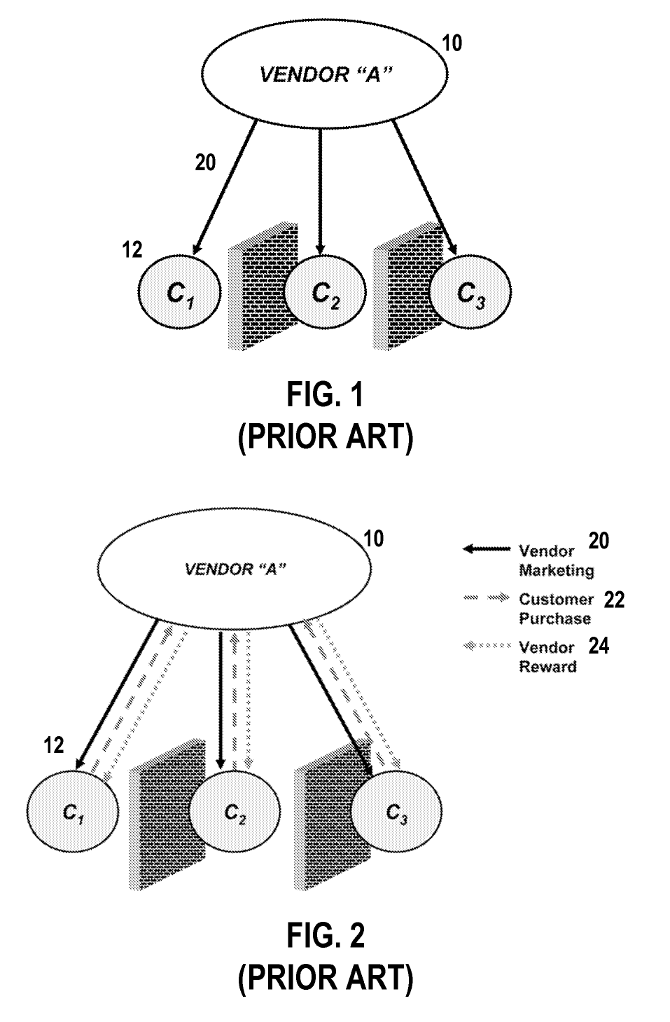

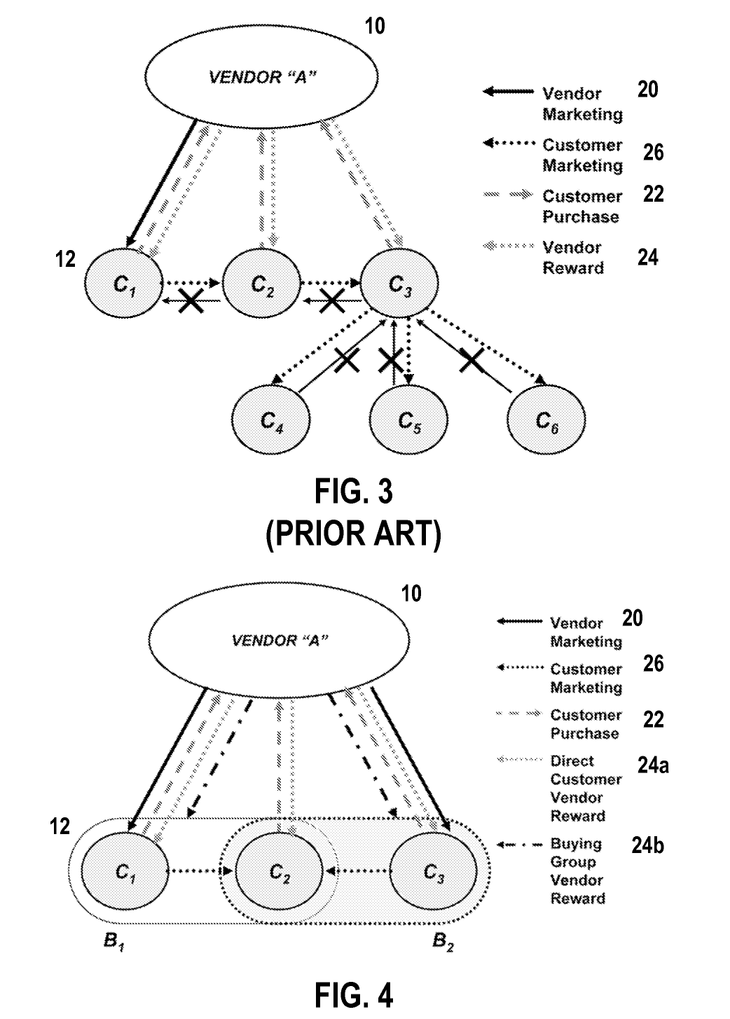

### DETAILED DESCRIPTION OF THE PREFERRED EMBODIMENTS

As illustrated in FIG. 4, in a preferred embodiment of the present invention, individual consumers C₁₋₃ 12 can dynamically form buying blocs B_{1,2} and thereby avail themselves of various vendor incentives 24b for purchasing as a group that would not be available for the individual 12 alone. In the illustrated example, the vendor 10 markets to a first customer C₁. Customer C₁ then forwards the marketing to a second customer C₂, and the second customer forwards the marketing to a third customer C₃. A relationship is maintained between the customers by creating a buying ring B₁. All members of the buying ring benefit from the purchases of other members of that ring in that the members of the buying ring are able to avail themselves of the greater buying group vendor reward 24b instead of the lesser direct customer vendor reward 24a. A customer may be a member of more than one buying ring (e.g., C₂ is a member of buying rings B₁ and B₂).

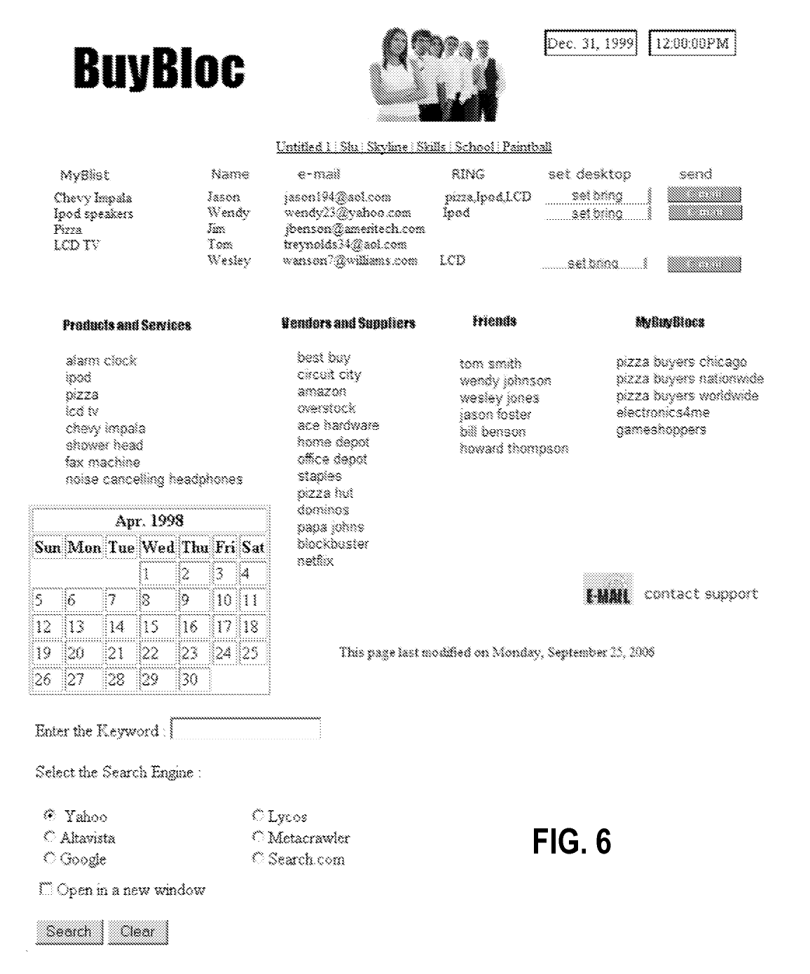

Ideally, this can be implemented via the use of a web site (FIG. 6) that serves as a meeting place for interested consumers 12, or this can be additionally or alternately implemented in a form of instant messaging. And through the use of a network based signaling mechanism that can reside on a person's computer and/or on a host system, providing a mechanism of alerting and signaling of buying opportunities between individuals and members of buying blocs.

By way of example, Bob is a frequent purchaser of pizzas. Bob knows that he can either order his pizza from Pizza Palace on-line by himself, or he can order his pizzas in a bloc and take advantage of incentives that Pizza Palace might be willing to offer for group purchases. In order to find others interested in buying a pizza from Pizza Palace, Bob could log on to a web site, similar, e.g., to myspace.com, and invite others to join him in purchasing pizzas from Pizza Palace. Alternately, he could enable a signal on his desktop that would search out and alert other possible participants about the purchase.

In this scenario, Bob logs on and conveys his interest in buying a pizza to others, and discovers that Jim and Cheryl are also interested in buying a pizza. If they all agree to purchase from Pizza Palace, e.g., then they can place their orders with Pizza Palace as a group. Of course, Pizza Palace would have to have provided some incentive for purchasing as a group. This incentive could be in the form of a reduced price on the purchase, a reduced price on a future purchase, coupons, additional products/services, or even a point system in which the purchaser acquires points that can be used on goods and services. Any form of incentive could be utilized, and the provision of incentives is primarily an accounting issue.

Note that the group purchase would not have to be implemented as a simultaneous purchase. The “group” purchase could be performed within some defined time period. For example, for pizza purchases, the purchases could be considered as a “group” purchase if made within three hours of each other, whereas for electronic purchases from Decent Buy, the “group” purchases could be performed within a week, and automobile purchases could be performed within two months. Some mechanism would have to be used for identifying purchasers as belonging to a particular buying group. This could be implemented by assigning each group a unique identifier that is used in common by each member of the group when making the purchase.

It could also be accomplished by the signaling mechanism, where authorization to make the purchase is delegated to the signal mechanism by each group member or member group (a participant can be an individual or a pre-defined group of individuals) and an authorized “bloc manager” can authorize purchases to be made by group members to take advantage of an opportunity. This can be accomplished electronically by the signal mechanisms on each participant's desktop.

In the above scenario and according to one embodiment, Bob, Jim, and Cheryl have all agreed to purchase a pizza from Pizza Palace and are therefore all given a group identifier to use when making their purchases. They are all aware of the need to purchase a pizza within some arbitrary time limit, e.g., three hours, in order to take advantage of the group incentives offered by Pizza Palace.

One difficulty is that since the purchases can be made at different times, the ultimate incentive cannot be determined until everyone completes their purchase. This is why incentives that involve points or future purchases may be utilized more effectively. If Bob and Jim follow through on their agreement to purchase, but Cheryl reneges, then Bob and Jim are only afforded an incentive offered for a two purchaser buying bloc instead of three. But this would not be known at the time Bob (who is first) orders his pizza.

One key component is that Pizza Palace did not have to reach out and contact Jim and Cheryl—Bob is the one who brought them on board for the purchase, which embodies the principles of viral marketing as well as those of group purchasing discounts. Furthermore, there is an incentive for Bob to get more people to join his group for the purchase due to increased incentives for numbers of people in the group (or possibly based on final sale dollar amounts).

This concept could be further extended in that Bob, as the initiator of the buying group, could be provided additional incentive. In this scenario, Bob could get $1.00 off of his next pizza as the group initiator, whereas Jim and Cheryl get $0.75 off of theirs.

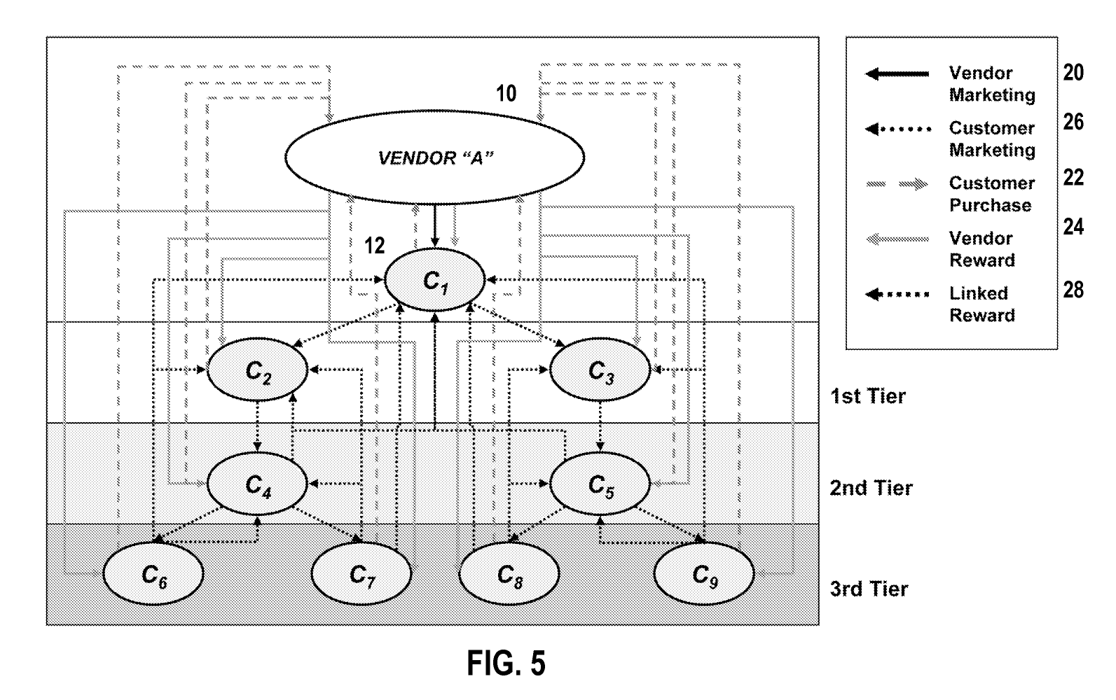

The concept could also incorporate this notion in a hierarchical structure form (see FIG. 5), where Bob C₁ initiates the formation of the group and receives a higher incentive. However, Cheryl C₂ then further gets her friends Sally C₄ and Bill (not shown) to join the group, giving her an additional incentive as well. This hierarchical structure form of incentives that cascade down into various tiers could serve as the basis for aggregating large blocs of purchasers based on collective incentives for all of the group members to get others to join. This organization would also encourage a person to be the first to form a buying bloc, since the incentives are greatest for those who join early on, thereby rewarding the frequency and immediacy of a call to action for a sale. However, there is still a substantial incentive for the late-joiners, given that the larger numbers infer greater rewards.

The concept could be implemented for contacts between friends (e.g., X e-mails a friend inviting him to join X in a pizza purchase), but could also be implemented anonymously. For example, the web site could have a lounge area that people make themselves available in. These people could preregister certain interests, either specifically, such as pizza, DVD players, etc., or generally, such as food, electronics, etc.

Thus, based on the preregistered interests, these individuals can be specifically targeted by those interested in making a particular purchase. Note that groups of friends (or buddies) could (and likely will) be implemented as a separate entity from those in a particular buying group. The group of friends would be those that a purchaser designates to share certain information with, whereas the buying group are those individuals (either from the “friends” group and/or anonymous individuals) who have banded together to make a particular purchase.

A form of instant signalling or messaging can also be used, in that a program runs, e.g., on a user's computer alerting others to an interest in making a purchase. For example, Bob identifies a number of friends (Jim and Cheryl) who have an interest in various food purchases. When Bob is interested in buying a pizza from Pizza Palace, he can log on to the web site and indicate his interest. Even though Jim and Cheryl are not logged in to the web site, because they have been identified as those in his friends group, they might see a pop-up screen in the form of an instant message inviting them in on the pizza purchase. Alternately, the web site might be unnecessary, as the software running on Bob's PC could directly contact Jim and Cheryl. In this scenario, everyone in Bob's friends group indicates those purchasing opportunities or other events that may be of interest.

The communication to friends could be in the form of a manual operation or an automatic operation. For example, Bob could manually send a message to Jim and Cheryl that he is interested in purchasing a pizza from Pizza Palace. Alternately, Bob could simply purchase a pizza, and an automated notice could be sent to Jim and Cheryl that a purchase has been made and that they can become a part of his group and make purchases themselves. The software for determining that Bob has made a purchase and that automatically sends a notice to Jim and Cheryl could be implemented in a program running on Bob's PC, or could even be provided by the vendor at their web site.

The notification could be configured by the user. For example, when Bob wishes to buy a DVD, he could configure his system to use a manual notification when he logs on to Decent Buy's web site, but to utilize an automatic notification when he actually makes a purchase. Again, the preferences and implementation could be done via a vendor web site, the common web site for buying groups, or by the program running on the user's PC, mobile device, cell phone, etc.

The actual mechanism could be accomplished via each vendor being supplied with a certain JavaScript or opinion type code that is put up on the pages that will then track that users activity whether or not they have hit certain trigger places that alert their buying ring buddies. As noted above, various parameters can be associated with other buddies as well as information associated with the vendor incentives (such as the time window in which a bloc purchase remains open).

As a side note, there is some incentive for everyone in a buying group to wait as long as possible before making a purchase, since the first person to buy in a buying group would set off the timer. For the pizza purchase, there is a tradeoff between getting the pizza quickly and waiting around to see if a much larger group can be formed. The communications between group members could also include various communications and/or agreements for the purchase (e.g., “let's wait another hour until 7:00 pm to make the first pizza purchase so we can get more people into our group”).

A form of reminders could be further implemented. For example, if Bob has made a DVD purchase from Decent Buy, thereby starting a 24-hour window for those in his group to be included, he could program a reminder to others in his group at the 12-hour point to remind them of the group discount available. This reminder could further include an indication of the number of others who have made similar purchases or intend to make similar purchases as a part of the group. The reminder could be time based, or could be based on other criteria, such as group size or discount available.

For example, an alert could be sent out to others in the group when the group size for actual purchases (or possibly intended purchases, or some combination) reaches 50 people. Alternately, an alert could be sent out when the DVD price drops below $9.00 due to the number of purchasers in the group or actual purchases made. These criteria can be established either by the original purchaser, the vendor, or prospective friends in the buying group. For example, Sally could see a pop-up message that Bob has purchased a DVD. Sally could then provide a parameter to alert her if the buying group is large enough such that she could purchase the DVD for $9.00. Similarly, Decent Buy could set up a similar form of alert on their web site.

When the incentive system is based on points, the points could either be essentially permanently redeemable, or they could terminate after some point in time, depending on the desires of the vendor. For points with a specific duration, a vendor could provide that a purchaser would not lose his points if the purchaser can induce someone else to buy a product. By way of example, Bob has accumulated 50 points with Pizza Palace that are set to expire on Friday evening. Even though Bob does not want to order a pizza on Friday, if he can induce Jim and Cheryl to make a purchase, he can preserve his accumulated incentive, providing him with motivation to interest others in purchasing even though he himself is not interested.

An interesting aspect in an embodiment is that members can keep tabs on the purchases made by others, and use that information to know whether someone has reneged, or is a habitual reneger. It can also be used so that group peer pressure is utilized to keep members in the group. For example, if a group regularly meets on myspace.com, and the group normally makes pizza purchases from Pizza Palace, if one of the members decides to start ordering from Papa John's, others in the group will be motivated to encourage the person not to defect from the group, and the larger the group, the more peer pressure there can be to keep people in the group. If a buddies group member starts jumping to different vendors, this may be structured to result in all of the others in the buddies group losing points thereby having them trying to persuade the person from leaving the group or going to a competitor.

Of course, the knowledge of others' buying habits would have to address issues of privacy, which could be agreed to in advance. Furthermore, any disclosures of purchased goods to others could simply be of a general nature—Bob may not mind his friends knowing that he recently made a purchase at McDonalds, but may not want them to know he ordered a quadruple quarter-pounder with cheese and an extra-large vanilla shake. The purchase information should, however, indicate the time the purchase was made so that others can know what the time constraints are to make the group purchase. But this information could be provided so that individuals who make frequent purchases would be known to be more desirable to have in a buying group, similar to the way that sellers and buyers on e-bay can be rated.

Such arrangements could permit a vendor, e.g., Pizza Palace, to do very customized e-mail marketing to the whole ring so that people in a ring have a much stronger affinity to go to Pizza Palace. When groups get larger, they can exercise more clout with the vendors in order to arrive at favorable terms. For example, if a regular bloc of 100 make pizza purchases on Friday evening, the bloc could use its clout to pit Pizza Palace against Dominionos in order to arrive at more favorable terms.

Although group sizes for certain products (e.g., pizza, with a fairly short time window) might be small, blocs could grow fairly large in size for, e.g., electronics purchases where the window remains open for a week.

Advantageously, this approach could keep individuals staying on certain sites, such as myspace.com, longer.

An alternative method suited to purchases that are not as time critical, such as the purchase of DVDs or electronics, would involve the initial user setting up all information necessary to generate a transaction with a chosen vendor, but then having that transaction put in a “hold” status. The transaction would not actually get created at that point, but a notification would then be sent to others wishing to participate in a shopping bloc for that vendor to let them know that there will be at least one other guaranteed purchase in their bloc if they place their own order within a pre-specified period of time.

In this scenario, the initial purchaser does not actually complete a transaction until the second shopper has also completed their transaction, with the second purchaser's transaction automatically generating a trigger to cause the initial transaction to be completed. This ensures for the first purchaser that they will have at least one more participant in their bloc before committing to a purchase.

The “hold” could also be extended until the expiration time of the bloc purchase in order to ensure that any discount could be determinatively applied to the present purchase itself for everyone in the bloc.

One of the features disclosed above is that when a consumer makes a particular purchase, others in his buddy group are notified of the purchase so that they can create a buying bloc and avail themselves of group discounts (prearranged by the vendor) within a certain period of time. The above description discloses the use of a program running on the user's computer or on a server that is aware of a purchase made by a user in a particular buddies group and alerts the other members of the group of the purchase. This system is based with online transactions/vendors with Internet-based notification to group members (either via e-mail or through an alerting application running on a PC).

However, when a customer is actually in a store shopping, he will likely not have direct access to a web browser or server. What is desirable is to provide the user with the ability to utilize coupon information associated with a purchase and, via his telephone, alert other users in his group to the fact that a purchase has been made. Thus, instead of it being based with online transactions/vendors with Internet-based notification to group members, it is desirable to provide this functionality to extend the group purchasing feature to offline sales and SMS-messaging.

The following example illustrates how this process could work, according to an embodiment of the invention.

As with the previously described group purchasing mechanism, a user sets up a list of other purchases as part of buying groups for various vendors or vendor categories for which incentives are issued as part of group purchasing. However, the user also designated both his own cell phone number as well as the cell phone numbers of the other members of the various purchasing groups.

The customer the goes to make an offline purchase at a participating vendor (e.g., Decent Buy). The Point-Of-Sale computer system used by the vendor to register the sale requests from the central group purchasing server provides a group purchasing code that is printed onto the receipt for the purchase.

The user then enters that group purchasing code as an SMS text message sent to the central server by way of a centralized shortcode. Such a shortcode could implement the well-known technology provided by the Common Short Code Administration (CSCA).

When the SMS message is received by the central server, it uses the cell phone number to look up the user's online account and based on the group purchasing code sent, it finds the vendor that issued the code. This, in turn, allows the system to identify all of the people within a particular group purchasing bloc that was set up by the original purchasing user. An SMS message with the group purchasing code, the vendor, and time period during which this code is valid is then sent to the cell phones of all the people in the group.

Upon receiving the SMS text message with the common group purchasing code for that particular purchasing block, another person in the purchasing block can then give that group purchasing code to the cashier to be entered into the store's POS system to allow their purchase to be associated with the original purchase (or even possibly extended to Internet or other off-site sales).

As subsequent purchases within the same bloc purchase are made, any people within the group who have not made a purchase can be sent subsequent notifications of each purchase made within that group. This allows people who have not yet purchased in that bloc to know that there is a higher level of incentive being generated. Parameters and rules can be set up by each user to limit the number of notifications they receive for any given purchasing bloc so as not to be flooded with notifications if a large number of people participate in a particular bloc purchase.

In an embodiment of the invention, the server from which the purchase is to be made can assign a code with, e.g., a particular life—this is a code that can be utilized then by other members joining the group and will be recognized by the server as a group identity. The code would be assigned to the first member either making a purchase or indicating an interest in forming a group to make the purchase.

Alternately, the code can be established by a group initiator when beginning the group formation or at some other time, and then shared with the server upon making a purchase or upon indicating to the server that a group with this identity code is forming. There should be no problem in either scenario for one sub-group abandoning its code in favor of joining another sub-group to form a larger buying bloc.

It should be noted that although the above communications have been defined in terms of well-known protocols, such as SMS text messaging, such an implementation is not essential to the invention. Any form of communications signalling utilizing any protocol or application-specific data transfer may be utilized.

The hardware utilized in the system can encompass any server-based system, personal computer, mobile device, including a cell phone, interactive TV (including digital cable and satellite applications delivered through set-top boxes) and/or internet-enabled game consoles (e.g., X-box 360, Nintendo Wii, etc.), comprising a processor, memory, non-volatile storage, user interface, and networking capability. The system comprises various software algorithms designed to run on the processors, and may be stored on any processor-readable media, such as CD-ROM, DVD, floppy disk or the like.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for group purchasing of a product or service, comprising:
determining, by a first customer, a product or service to purchase from a vendor;
contacting, by the first customer, at least a second customer interested in purchasing the product or services;
establishing a customer-defined group identity with the first and second customer being group members;
purchasing the product or service from the vendor by the first and second customer using the group identity;
providing, by the vendor, a benefit that is at least one of a pre-purchase incentive and a post-purchase reward to the first and second customer based on the group identity.

2. The method according to claim 1, wherein the contacting comprises extending an invitation to purchase the product or service that contains information about the product or service to the second customer.

3. The method according to claim 2, wherein the first customer logs into a server and accesses an algorithm located on the server to initiate extending the invitation to the second customer.

4. The method according to claim 2, wherein the first customer accesses an algorithm located on a personal computer or mobile device to initiate extending the invitation to the second customer.

5. The method according to claim 2, further comprising receiving the invitation on a server by the second customer via an alert.

6. The method according to claim 2, further comprising receiving the invitation on a personal computer or mobile device by the second customer via an alert.

7. The method according to claim 1, wherein the contacting comprises an action selected from the group consisting of: sending an e-mail, sending a text message, and sending an application-specific or protocol-specific data block.

8. The method according to claim 1, wherein the benefit is dependent upon group size.

9. The method according to claim 1, wherein the contacting is performed automatically by a software algorithm located at a vendor web site, a common buying group web site, or process running on a computer, mobile device or cell phone of the first customer.

10. The method according to claim 1, wherein the purchasing by the first customer is done subsequent to the contacting and establishing.

11. The method according to claim 1, wherein the contacting is done subsequent to the purchasing by the first customer.

12. The method according to claim 11, wherein the purchasing by the first customer is an in-store purchase from the vendor.

13. The method according to claim 1, further comprising defining, by the vendor, a period of time within which the group members much purchase in order to receive the benefit.

14. The method according to claim 1, further comprising varying, by the vendor, an amount of the benefit based on a group size actually making the purchase.

15. The method according to claim 1, further comprising defining and identifying the first customer as a group initiator and providing, by the vendor, an additional benefit to the group initiator.

16. The method according to claim 15, further comprising tracking a number of group members added by the group initiator and defining the additional benefit to be dependent upon the number added.

17. The method according to claim 15, further comprising, defining and identifying customers other than the group initiator as being sub-group initiators based on their inducement of other customers to join the group, and providing a further additional benefit to the sub-group initiators, the defining and identifying being done in a hierarchical manner.

18. The method according to claim 17, further comprising tracking a number of group members added by the sub-group initiators and defining additional benefit to the sub-group initiators to be dependent upon the number added by the respective sub-group initiators.

19. The method according to claim 1, further comprising providing a reminder, by the first customer, to the second customer.

20. The method according to claim 19, wherein the reminder includes information on at least one of a quantity of others who have made the purchase and a quantity of others who intend to make the purchase.

21. The method according to claim 19, wherein the reminder is a time-based reminder.

22. The method according to claim 19, wherein the reminder is based on a quantity of group members who have already made the purchase.

23. The method according to claim 1, wherein the benefit is a vendor-based point system.

24. The method according to claim 1, wherein the purchasing comprises generating a hold transaction with the vendor by the first customer, and only completing the purchase of the first customer by the vendor when the second customer completes the purchase.

25. The method according to claim 1, further comprising establishing and storing parameters and rules for contacting others as more group members make purchases.
